(19) United States
(12) Patent Application Publication
(10) Pub. No.: US 2024/0416902 A1
(43) Pub. Date: Dec. 19, 2024

(54) SAFETY APPARATUS FOR A VEHICLE AND METHOD

(71) Applicant: Robert Bosch GmbH, Stuttgart (DE)

(72) Inventors: Benjamin Schnarr, Nufringen (DE); Sejfel Fazli, Gerlingen (DE)

(21) Appl. No.: 18/644,395

(22) Filed: Apr. 24, 2024

(30) Foreign Application Priority Data
Jun. 16, 2023 (DE) 10 2023 205 639.9

(51) Int. Cl. B60W 30/09; B60W 30/095; B60W 30/14; B60W 30/18

(52) U.S. Cl. CPC B60W 30/09; B60W 30/0956; B60W 30/146; B60W 30/18159; B60W 2420/403; B60W 2420/408; B60W 2420/54

(57) ABSTRACT

A safety apparatus for a vehicle and a corresponding method. The vehicle includes a device for automated longitudinal and lateral guidance of the vehicle, in particular for automatic maneuvering of the vehicle, wherein the vehicle has at least one surroundings sensor system, and actuating units for actuating the vehicle steering system, the vehicle drive devices, and/or the vehicle deceleration devices. When the device for automated longitudinal and lateral guidance maneuvers the vehicle into a traffic space being traveled in, and the surroundings sensor system detects a moving object that has a probability of collision with the host vehicle, the host vehicle is braked to a standstill, the direction of travel is changed and the vehicle is maneuvered back along a path until the probability of collision is minimized.

### CROSS REFERENCE

The present application claims the benefit under 35 U.S.C. § 119 of German Patent Application No. DE 10 2023 205 639.9 filed on Jun. 16, 2023, which is expressly incorporated here by reference in its entirety.

The present invention relates to a safety apparatus for a vehicle and to a corresponding method, wherein the vehicle comprises a device for automated longitudinal and lateral guidance of the vehicle, in particular for automatic maneuvering of the vehicle, wherein the vehicle has at least one surroundings sensor system, actuating units for actuating the vehicle steering system, the vehicle drive devices and/or the vehicle deceleration devices, and, when the device for automated longitudinal and lateral guidance maneuvers the vehicle into a traffic space being traveled in and the surroundings sensor system detects a moving object that has a probability of collision with the host vehicle, the host vehicle is braked to a standstill, the direction of travel is changed and the vehicle is maneuvered back along a path until the probability of collision is minimized.

### BACKGROUND INFORMATION

German Patent Application No. DE 10 2020 214 029.4 A1 describes a method and an apparatus for controlling a safety device of a vehicle and a safety system for a vehicle that reacts to an imminent collision of the vehicle with a collision object by intervening in a longitudinal guidance and/or lateral guidance of the vehicle, in which surroundings data and trip data are read in, a speed, a mass or an acceleration of the collision object in the surroundings of the vehicle are ascertained and seat occupancy data are ascertained via an occupancy status of at least one seat of the vehicle by occupants. An expected impingement side of the collision object on the vehicle is ascertained and evaluated using the surroundings data and technical data and the seat occupancy data.

### SUMMARY

An object of the present invention is to provide a method and an apparatus that allow collision situations in road traffic to be detected and subsequently avoided or minimized, thereby increasing road safety. This may be achieved according to features of the present invention. Advantageous developments and example embodiments of the present invention are disclosed herein.

It is intended to further develop a vehicle that is provided with a device for automated longitudinal and lateral guidance of the vehicle and that has at least one surroundings sensor system for this purpose. Such vehicles often have an apparatus or method for automatically maneuvering the vehicle, for example an apparatus and/or method for maneuvering the vehicle into a parking space or parking bay, maneuvering the vehicle out of a parking space or parking bay, maneuvering the vehicle out of a complicated exit or maneuvering the vehicle through a complicated intersection. For this purpose, the method or apparatus can have actuating units for the vehicle steering system or the vehicle lateral guidance system as well as the vehicle longitudinal guidance system, including vehicle drive devices and/or vehicle deceleration devices. If an object in the vehicle surroundings that has a probability of collision with the host vehicle is detected while driving in a complicated traffic space, preferably using the device or method of the present invention for automated longitudinal and lateral guidance of the vehicle, the host vehicle can be braked during automated maneuvering, the direction of travel can be changed and the vehicle can be maneuvered back along a path until the probability of collision is minimized. This makes it possible, for example, if a vehicle is rapidly approaching as the host vehicle is pulling out of a parking space and in order to avoid a collision, to abort the parking space exit operation, change the direction of travel of the host vehicle and maneuver back into the parking bay or parking space until the risk of collision with the approaching vehicle has been minimized.

In the context of the present invention, reference is made to low speeds. The line between low speeds and high speeds cannot be defined by a fixed speed threshold, but rather the low speeds are a speed range in which the vehicle is not primarily used to travel a certain distance, but is used, for example, to maneuver into parking spaces, maneuver out of parking spaces, maneuver out of complicated driveways or maneuver through intersections with poor visibility. In contrast, the high speeds are driving situations in which traveling a planned path dominates and the vehicle does not have to be maneuvered over complicated traffic segments. Although it is hardly possible to set a limit speed to make a general distinction between maneuvering speeds and driving speeds, the range between these two speed ranges should be between approximately 15 km/h and approximately 30 km/h, preferably 20 km/h or 25 km/h.

The minimization of the probability of collision can be understood as a reduction, but it can also be reduced to zero and thus disappear completely. Minimization can, for example, consist in continuously calculating the probability of collision based on the traffic situation and continuing to maneuver back until said probability of collision increases again. In this case, the local minimum has been exceeded, so that even stopping after said local minimum has been exceeded and slightly increased again is still understood as minimizing the overall risk of collision.

For example, the danger of collision may increase again when a vehicle is maneuvered back into a parking space and approaches a vehicle parked next to it, as a result of which the danger of collision at the rear is increased by approaching the parked vehicle, while the danger of collision at the front by the approaching vehicle is reduced. In this case, the overall probability of collision consisting of both collision dangers is therefore decisive. The overall probability of collision must be minimized or reduced to zero.

According to an example embodiment of the present invention, it is advantageously provided that the device for automated longitudinal and lateral guidance of the vehicle is a device for maneuver assistance at low speeds. Such a maneuvering assistant can be, for example, an automatic parking space entry assistant, an automatic parking space exit assistant, a maneuvering assistant, an assistant for entering a complicated intersection or an assistant for driving onto an exit, which are known on the market as FCTAs, i.e., Front Cross Traffic Assistants or FRTAs, Front Rear Traffic Assistants, i.e., systems that have sensors at the vehicle front that detect traffic objects to the left and right substantially perpendicular to the vehicle longitudinal axis or systems in which systems are arranged at the vehicle rear that monitor substantially perpendicular to the vehicle longitudinal axis the region from the left and right of the vehicle to perpendicular to the host vehicle in the direction of approaching vehicles.

Furthermore, it is advantageously provided according to an example embodiment of the present invention that the vehicle has a detection unit for detecting a path traveled, a memory for storing the longitudinal movement and the lateral movement during the path traveled. For this purpose, if an object is detected that has a probability of collision with the host vehicle, the host vehicle can be braked to a standstill, the direction of travel can be changed and the host vehicle can be maneuvered back along the stored path. In particular when pulling out of a parking space or parking bay, the vehicle travels along a driving path stored in a memory device in terms of speeds, distances and steering wheel angles. Such a memory unit can be a odometry unit, for example. If a danger of collision with a vehicle approaching on the road is detected when pulling out of the parking bay or parking space, the host vehicle can be slowed down and driven back along the same path that the vehicle traveled when pulling out of the parking space.

When maneuvering back, the vehicle surroundings can be detected with regard to previously known objects or newly added objects can also be detected, for example pedestrians crossing the driving path behind the vehicle pulling out who are endangered if the vehicle maneuvers back.

Furthermore, according to an example embodiment of the present invention, it is advantageous for the device for maneuver assistance to be an automatic parking space exit system for removing the vehicle from a parking space, an automatic parking space exit system for removing the vehicle from a parking pocket or parking bay, a Front Cross Traffic Assist (FCTA) for exiting a driveway or for entering an intersection. Such systems, which monitor the vehicle surroundings in complicated situations and can monitor lanes before the driver is able to see the situation due to the position of said driver in the vehicle, can already recognize approaching objects. Such systems can warn the driver or brake the vehicle to a standstill in good time.

According to an example embodiment of the present invention, it is also advantageous if the traffic space being traveled in is a lane of a road or an intersection region of a road intersection. In this case, a traffic space being traveled in is a public traffic space that is often complicated due to roadside structures or other parked vehicles and is therefore prone to accidents. For example, driving situations where the vehicle enters or exits a garage or drives into a parking space on a property are not considered to be traffic spaces because the danger of collision with another approaching vehicle or object in particular should be detected and mitigated.

Furthermore, according to an example embodiment of the present invention, it is advantageous that the probability of collision results from the direction of movement of the object and the vehicle, their speeds in order to avoid a possibility of collision. In this case, the probability of collision can be a calculated numerical value that takes into account all the circumstances that lead to a collision. For example, a probability of collision can be set to zero if there is sufficient time for the vehicles to slow down from their current speed and come to a stop without a collision. A probability of collision can be assumed to be 1 if the speed and distance of the vehicles are such that a collision can no longer be avoided even if the vehicles brake with the maximum possible deceleration. In this case, other collision values can take into account the fact that the higher the danger of collision, the more one of the two vehicles must brake, or an atypical steering movement must be made to avoid the collision.

According to an example embodiment of the present invention, it is also advantageous that the vehicle is maneuvered back along the stored path until the risk of collision no longer exists. As soon as the vehicle has been maneuvered back to the original position of the parking space or the parking pocket or the exit, as it was originally parked, the traffic space being traveled in, namely the traffic lane of the adjacent road being traveled on, is free and a collision risk of zero can therefore be assumed, provided that one of the parked neighboring vehicles has not moved in the meantime or other road users such as pedestrians or cyclists have approached the original parking position.

Furthermore, according to an example embodiment of the present invention, it is advantageously provided that, during the maneuvering of the vehicle back along the stored path, the detection region of the surroundings sensor system is monitored by means of the at least one surroundings sensor system and, if a further object is detected within the stored path, the host vehicle is braked to a standstill or the host vehicle is maneuvered around the detected further object. If the surroundings sensor system has detected that there is sufficient maneuvering space, it is possible to plan a driving trajectory as a collision avoidance trajectory in which the vehicle steers around the object. This means that an evasive maneuver due to a steering maneuver is also conceivable in order to avoid a collision with the approaching object. In this case, an evasion trajectory is determined that does not correspond to the evasion trajectory or maneuver trajectory traveled immediately before to cross an intersection.

Furthermore, according to an example embodiment of the present invention, it is advantageous that the at least one surroundings sensor system consists of at least one radar sensor or a plurality of radar sensors, at least one video sensor or a plurality of video sensors, one or a plurality of ultrasonic sensors, one or a plurality of lidar sensors or a combination of these sensor types. These are advantageously attached to the vehicle corners of the vehicle in such a way that they can detect the regions in front of and/or behind the vehicle. Optionally, it is also conceivable that regions on the side of the vehicle can be detected both to the left and right of the regions and/or the rear vehicle. As part of a Cross Traffic

Assist (CTA), i.e., an assistance system that warns of cross-traffic, sensors are often installed at the vehicle corners so that their main beam direction is oriented perpendicular to the vehicle longitudinal axis and monitor the regions to the left and right of the vehicle. This makes it possible to use the front sensors to detect intersection traffic at an early stage when exiting properties or entering intersections, even if the driver cannot yet see this region due to the reclined seating position of said driver in the vehicle. Cross-traffic assist sensors of this type can be used particularly advantageously here. Furthermore, it is advantageous that the device for automated longitudinal and lateral guidance of the vehicle is a device for maneuver assistance at low speeds.

Furthermore, according to an example embodiment of the present invention, it is advantageously provided that the path traveled is recorded in a recording unit that has a memory. The longitudinal movement and the lateral movement can be stored in this memory while traveling along the path. This device can advantageously be referred to as a odometry unit. If an object is detected that has a probability of collision with the host vehicle, the host vehicle can be braked to a standstill, the direction of travel can be changed and the host vehicle can be maneuvered back along the stored path along which it was guided.

Advantageously, according to an example embodiment of the present invention, the vehicle can be maneuvered and/or maneuvered back up to a predetermined maximum speed. This maximum speed is intended to separate the maneuvering speed from the driving speed and is, for example, between 10 and 25 kilometers per hour, preferably in the range of 10 km/h or 15 km/h.

The method(s) according to the present invention can be implemented, for example, in software or hardware or in a mixed form of software and hardware, for example in a control unit.

The approach according to the present invention presented here furthermore provides a distance controller that is designed to carry out, control or implement the steps of a variant of the method presented here in corresponding devices.

The safety device may be an electrical instrument having at least one computing unit for processing signals or data, at least one memory unit for storing signals or data, and at least one interface and/or one communication interface for inputting or outputting data embedded in a communication protocol. The safety apparatus can, for example, be a signal processor, a so-called system ASIC, or a microcontroller for processing sensor signals and outputting data signals on the basis of the sensor signals. The safety apparatus can, for example, be a flash memory, an EPROM, or a magnetic memory unit. The interface can be designed as a sensor interface for reading in the sensor signals from a sensor and/or as an actuator interface for outputting the data signals and/or control signals to an actuator. The communication interface can be designed to read in or output the data in a wireless and/or wired manner. The interfaces may also be software modules that are present, for example, on a microcontroller in addition to other software modules.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to one of the example embodiments of the present invention described above is advantageous as well, in particular when the program product or program is executed on a computer, a programmable control unit or a similar apparatus.

Some of the possible features and advantages of the present invention are described with reference to various embodiments as a method for controlling a safety apparatus. A person skilled in the art will recognize that the features can be suitably combined, adapted, or replaced in order to arrive at further embodiments of the present invention.

### BRIEF DESCRIPTION OF THE DRAWINGS

Exemplary embodiments of the invention are explained below with reference to drawings. In the drawings:

FIG. 1 shows a first traffic situation to illustrate the present invention.

FIG. 2 shows another traffic situation to illustrate the present invention.

FIG. 3 shows another traffic situation to illustrate the present invention.

FIG. 4 shows another traffic situation to illustrate the present invention.

FIG. 5 is a schematic block diagram illustrating an exemplary embodiment of the safety apparatus according to the present invention.

FIG. 6 is a schematic flowchart illustrating the method according to an example embodiment of the present invention.

### DETAILED DESCRIPTION OF EXAMPLE EMBODIMENTS

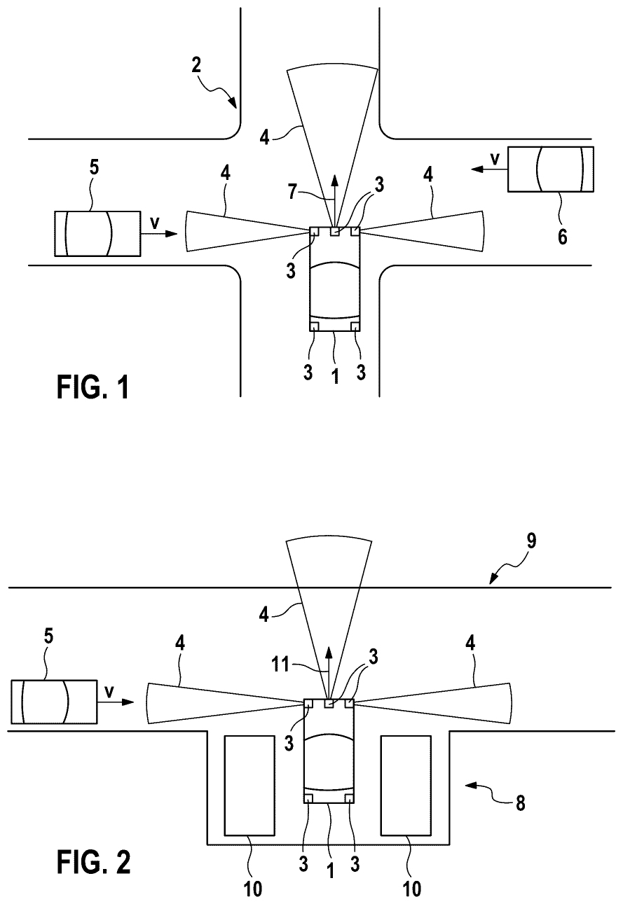

FIG. 1 shows an example of a traffic situation at a road intersection 2. The host vehicle 1 is approaching this road intersection 2. Due to the complicated nature of the intersection 2, the host vehicle 1 enters the intersection region of the road intersection 2 slowly. The host vehicle 1 has a surroundings sensor system 3, which can, for example, consist of a plurality of surroundings sensors 3, wherein the surroundings sensors 3 can in turn consist of different types of sensors such as radar sensors, video sensors, ultrasonic sensors or lidar sensors. An example of a surroundings sensor system 3 is shown, which has a sensor 3 at the vehicle front that covers a detection region 4 in front of the host vehicle 1, so that this first surroundings sensor 3 covers the future course region of the host vehicle 1. Furthermore, surroundings sensors 3 are shown at the vehicle corners of the host vehicle 1, whose main beam directions of the detection regions 4 are aligned in such a way that they are oriented perpendicular to the vehicle longitudinal axis, for example. This makes it possible for the detection regions 4 of the surroundings sensors 3 mounted on the corners of the host vehicle 1 to detect crossing traffic objects 5, 6 at an early stage as the host vehicle 1 approaches the traffic intersection 2, even though the driver is not yet able to detect these objects 5, 6 because said driver is sitting in a position that is further back in the host vehicle 1 in the direction of travel 7 than the surrounding sensors 3. If the host vehicle 1 enters the road intersection 2 and moves with the speed vector 7, crossing traffic objects 5, 6, which in turn are moving towards the host vehicle 1 at speeds v, can be detected.

If a collision risk is detected based on the distances and speeds v of the vehicles approaching from the left 5 and the vehicle approaching from the right 6, the safety apparatus and the safety method in the host vehicle 1 can initiate appropriate actions. For example, a collision risk can be calculated in such a way that a braking deceleration is calculated that is required to avoid a collision, and a collision risk is assessed on the basis of the amount of braking deceleration required by the approaching vehicles 5, 6, depending on the amount of deceleration ascertained. The evasion of the approaching vehicle 5, 6 can also be taken into account. If a collision risk is detected when the host vehicle enters the road intersection 2, the host vehicle 1 is braked according to the invention in its direction of travel 7, a change in direction of the host vehicle 1 is initiated and the host vehicle 1 is maneuvered out of the intersection region 2 in the opposite direction to the original direction of travel 7. In the case of a vehicle 1 having an internal combustion engine and automated transmission, for example, the change in direction can be designed in such a way that reverse gear is engaged when the vehicle is at a standstill and the host vehicle 1 continues to move backwards. In the case of a host vehicle 1 having an electric drive, the direction of travel can be changed by reversing the direction of rotation of the electric motor or, if a transmission is used, the transmission can also be changed in its direction of travel.

FIG. 2 shows another exemplary traffic situation in which the host vehicle 1 has been parked in a parking space 8 so that the longitudinal direction of the host vehicle 1 is oriented perpendicular to the usual direction of travel on the public road 9. Other parked objects 10 are shown to the side of the host vehicle A1, which restrict the ability of the driver of the host vehicle 1 to see approaching traffic objects 5. As part of an automated parking space exit operation or a manual parking space exit maneuver, the host vehicle 1 is maneuvered out of the parking space along the speed vector 11 using its surroundings sensor system 3. As soon as the host vehicle 1 has left the parking space far enough in the forward direction that the surroundings sensors 3 at the front vehicle corners can see into the road with their detection regions 4 to the left and right in relation to the direction of travel of the host vehicle 1, approaching traffic objects, such as the exemplary vehicle 5 shown, can be detected and a possible danger of collision between the approaching vehicle 5 and the host vehicle 1 can be calculated. If a sufficiently high risk of collision between the approaching vehicle 5 and the host vehicle 1 is ascertained, the host vehicle 1 is braked according to the invention, the direction of travel 11 is changed to reverse and the host vehicle 1 is maneuvered into the parking space. The vehicle 1 is advantageously only maneuvered into the parking space until the original parking position is reached in order to avoid driving onto the adjacent pedestrian path or colliding with an adjacent building or traffic sign. In this case, the host vehicle 1 can be braked, the direction of travel can be changed and the host vehicle 1 can be maneuvered back, regardless of whether the parking space exit operation of the host vehicle is automated or whether the parking space exit operation is carried out manually by the driver of the host vehicle 1, in which case the driver is overridden by the safety apparatus with regard to the accelerator and brake pedal actuations of said driver.

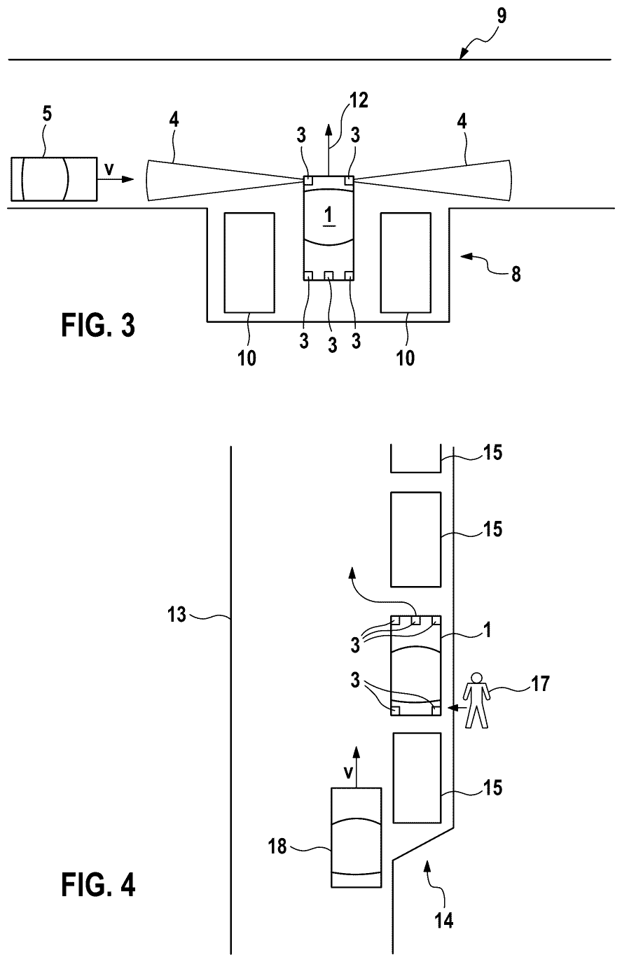

FIG. 3 shows a traffic situation that is very similar to the traffic situation in FIG. 2. The host vehicle 1 is again parked in a parking space whose orientation is perpendicular to the direction of travel of the public road 9. The parked host vehicle is adjacent to parked objects 10 on both sides, so that the driver's view of the road 9 is restricted. In contrast to the situation in FIG. 2, in the present FIG. 3 the host vehicle is parked in such a way that it has to be moved in the reverse direction 12 to exit the parking space 8, which further reduces visibility and once more increases the risk of a collision with an approaching vehicle 5. The host vehicle 1 having a surroundings sensor system 3 is maneuvered out of the parking space 8 in the reverse direction 12 and the parking maneuver can be performed either by means of an automatic parking assistant or automatic parking space exit assistant or by manual actuation by the driver of the host vehicle 1. If the host vehicle 1 has moved far enough out of the parking space 8 for the vehicle sensor system 3 at the rear vehicle corners to be able to detect the road 9 with their detection regions perpendicular to the direction of travel 12 of the host vehicle 1, it is possible to detect approaching objects, such as the vehicle 5 shown in the example. If an increased risk of collision is calculated based on the distance between the approaching vehicle 5 and the host vehicle 1 as well as the relative speed, the safety device can again brake the vehicle 1 exiting the parking space to a standstill, change the direction of travel of the host vehicle 1 from reverse to forward and maneuver the host vehicle 1 in a forward direction into the parking space 8 in order to minimize or eliminate the risk of collision with the approaching vehicle 5. In the case of an automatic parking space exit maneuver, the safety device and the corresponding method can cancel this maneuver and maneuver the host vehicle 1 back into the parking space accordingly or, in the case of a manual parking space exit maneuver performed by the driver of the host vehicle 1, override the driver requests using the accelerator pedal, brake pedal and steering. The host vehicle 1 is only driven far enough into the parking space 8 to avoid colliding with adjacent objects or driving onto a pedestrian path. This can be achieved by maneuvering the host vehicle 1 only as far into the parking space 8 until the original parking position is reached. In this case, this would have to be stored and the corresponding vehicle movements along the trajectory while exiting the parking space would have to be stored.

FIG. 4 shows another traffic situation in which parking bays 14 or parking pockets 14 are arranged along the public roads 13 in a direction parallel to the direction of travel of the road 13. The host vehicle 1 is parked in one of the parking pockets and is surrounded by parked objects 15 both at the front and at the rear. The host vehicle 1 wants to pull out of the parking pocket and must perform a combined steering and driving trajectory according to arrow 16. For this purpose, the surroundings sensors 3 are used to detect approaching objects, such as the approaching vehicle 18 shown as an example. If the surroundings sensor system 3 detects a risk of collision with the approaching vehicle 18, the parking space exit maneuver of the host vehicle 1 along the parking space exit trajectory 16 is also aborted in this case or the maneuver performed by the driver is overridden by the host vehicle 1 being braked to a standstill, changing its direction of travel and maneuvering the host vehicle 1 back into the parking space between the parked objects 15. In all exemplary embodiments, in particular FIGS. 2, 3 and 4, it is important to note that other objects in the vehicle surroundings, such as the pedestrian 17 shown, are detected by the surroundings sensor system 3. If the position of the pedestrian 17 approaches between the parking space exit operation and the return maneuver of the vehicle, the host vehicle 1 may only be maneuvered back into the parking space or parking pocket so far that the pedestrian 17 is not touched. It may be necessary to stop maneuvering the host vehicle 1 back before the original parking position has been reached. Alternatively, it is also conceivable that an additional steering movement is used to drive around the object 17 whose location is changing, wherein no collisions with other objects may occur.

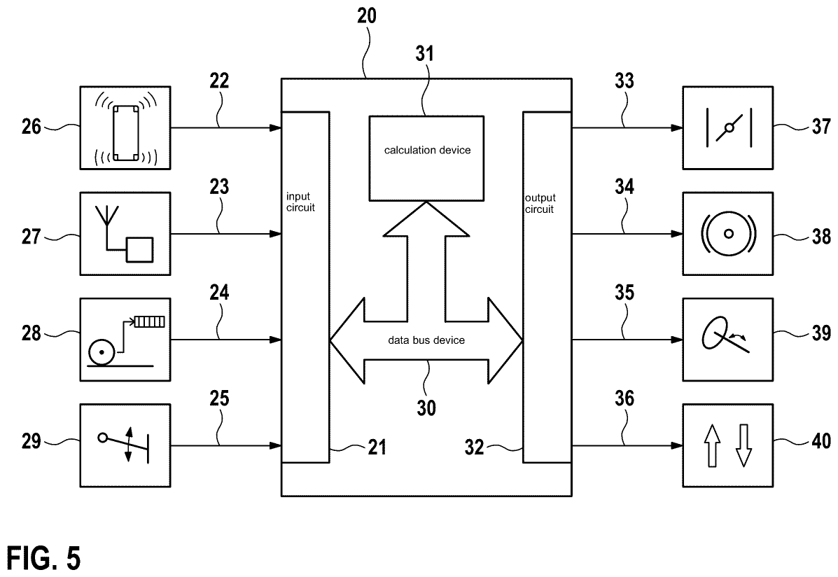

FIG. 5 shows an exemplary embodiment of the safety apparatus 20. The safety apparatus 20 contains a device for automated longitudinal and lateral guidance of the vehicle 1, as may be known for example from the prior art. Within the scope of the invention, however, it is also possible for the device-automated longitudinal and lateral guidance of the vehicle 1 to be accommodated in a separate control unit and for the safety apparatus 20 and the separate control unit to be connected by means of a data bus system. The safety apparatus 20 has an input circuit 21 via which input signals 22, 23, 24, 25 are supplied from devices 26, 27, 28, 29 that provide input signals. For example, a surroundings sensor signal 22 from a surroundings sensor 26 is supplied to the input circuit 21. The surroundings sensor system 26 can access the surroundings sensors 3 at the vehicle corners and in the region of the vehicle exterior of the host vehicle 1. It is also conceivable that surroundings sensors 3 supply their data in a data fusion model, that the data fusion model calculates a surroundings model as software and that this calculated surroundings model is made available to the input circuit 21 by the surroundings sensor system 26 in FIG. 5 via the surroundings sensor signal 22. Furthermore, the input circuit 21 is supplied with an infrastructure vehicle signal 23, which can be provided by a data receiving unit 27. In the case that sensors are present in other vehicles that can collect surroundings data and make them available to the host vehicle 1 or in the case that surroundings data are collected by means of infrastructure-based sensors at the roadside or in parking lots and these data are made available to the host vehicle 1 via infrastructure-to-vehicle communication, these externally collected data can also be used to carry out the method according to the invention. However, the use of these external object data from a receiving unit 27 is only an optional component of the apparatus according to the invention.

Furthermore, an odometry signal 24 is provided to the input circuit 21 by an odometry unit 28. This odometry unit 28 stores data relating to the speed, the path traveled, the direction of travel of the host vehicle 1 and the associated steering signals when the host vehicle 1 exits the parking space. By knowing these odometry signals, it is possible to reverse the driving path traveled and, provided no other moving object has crossed the driving path in the meantime, to return to the original parking position. Furthermore, the input circuit 21 is supplied with an operating signal 25 from an operating device 29, via which the apparatus according to the invention can be activated, for example, or additional settings can be activated or deactivated. The input signals 22, 23, 24, 25 supplied to the input circuit 21 are supplied via the data bus device 30 to a calculation device 31, which may be, for example, a microprocessor or a microcomputer on which the method according to the invention is implemented as software. The signals supplied to the calculation device 31 are processed as input signals and output signals according to the invention are generated therefrom, which are output by the calculation device 31 to an output circuit 32 via the data exchange device 33. The output circuit 32 outputs output signals 33, 34, 35, 36 to downstream devices 37, 38, 39, 40. For example, an acceleration signal 33 is output to an acceleration actuator 37, whereby the host vehicle 1 can be accelerated in its current direction of travel. Furthermore, a deceleration signal 34 is output via the output circuit 32, which deceleration signal can control the deceleration device 38, in particular the brakes of the host vehicle 1, and thus decelerate the host vehicle in its current direction of travel. This deceleration is possible until the host vehicle 1 comes to a standstill. The output circuit 32 further outputs a longitudinal signal 35 to a steering actuator 39 so that the host vehicle 1 can also be steered accordingly during its parking space exit maneuver to maneuver the host vehicle 1 in the public traffic space 2, 9, 13 so that the host vehicle 1 can begin its journey and be threaded into the flowing traffic. Furthermore, a change in direction of travel signal 36 is output via the output circuit 32, which is supplied to a direction of travel actuator 40. This direction of travel actuator 40 is able to change the direction of travel of the host vehicle 1, for example by designing the direction of travel actuator 40 as an automatic transmission that can change the direction of travel from forward to reverse or from reverse to forward via corresponding input signals.

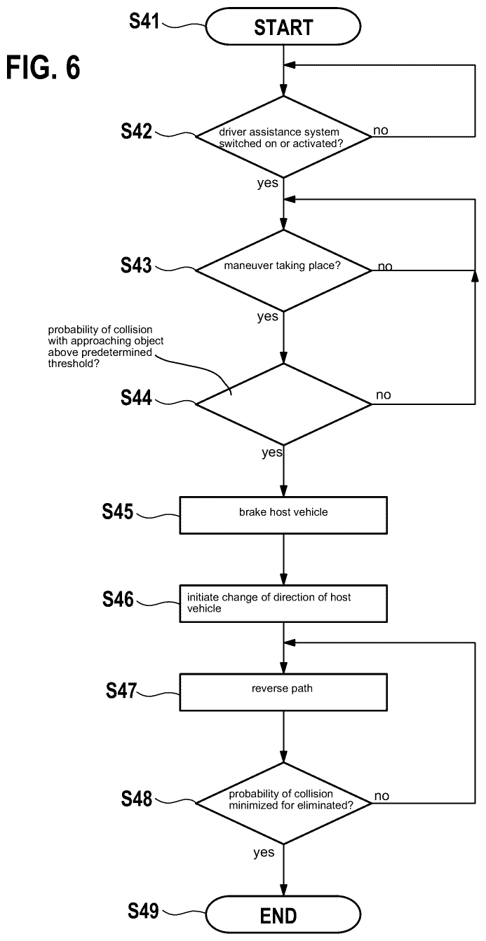

The following FIG. 6 shows an exemplary embodiment of the method according to the invention. This begins in step S41 in that the method according to the invention is started, for example in that the method of the safety device is activated. In the following step S42, it is determined whether the driver assistance system is switched on or activated. This driver assistance system can, for example, be a parking space exit system for maneuvering a host vehicle 1 out of a parking space or parking pocket. If step S42 was decided with a no, it branches to step S42 and waits until this loop in step S42 is decided with a yes. If the driver assistance system is switched on, step S42 branches to yes and the method continues in step S43 by determining whether a maneuver is taking place in a traffic space being traveled in. The traffic space being traveled in can be a public road where parking spaces are aligned parallel to the direction of travel of the road or perpendicular to the direction of travel of the adjacent road. The public traffic space can also be a driveway or an intersection that is difficult to see or any other traffic situation that is difficult to see and therefore presents an increased risk of collision. As long as such a traffic situation has not been recognized, step S43 branches back to step S43. If it was recognized in step S43 that such a traffic situation exists, step S43 branches to yes and the method continues in step S44 by a probability of collision with an approaching object 5, 6 being ascertained. If the ascertained probability of collision is above a predefined threshold value, which can be ascertained, for example, from the distance and relative speed of the approaching objects 5, 6 to the host vehicle 1, step S44 branches to yes and the method continues in step S45. As long as the probability of collision does not exceed the specified threshold value in step S44, the method branches back and continues in step S43. If an increased probability of collision was detected in step S44, the host vehicle 1 is braked in the following step S45 until it comes to a standstill. Immediately afterwards, in step S46, a change of direction of the host vehicle 1 is initiated and in the following step S47 the path is reversed. In step S47, the previously traveled path can be traveled back to the original stop position or alternative paths can also be traveled, for example if objects have been detected by the surroundings sensors, which, during the parking space exit maneuver or the insertion maneuver into the complicated intersection, enter or drive on the previously traveled path and therefore a collision could be caused by the return maneuvering. In the following step S48, the system continuously checks whether a probability of collision has been minimized or eliminated during the return maneuver. The probability of collision is minimized or eliminated by the fact that the host vehicle 1 has left the driving path of the approaching object 5, 6 and that the approaching vehicle 5, 6 can therefore no longer collide with the host vehicle 1 or can easily maneuver around the host vehicle 1. In step S48, not is only the probability of collision of the host vehicle 1 with approaching objects 5, 6 ascertained, but it is also monitored with other objects 17 in the vehicle surroundings, for example pedestrians, which move into the traveled driving trajectory of the host vehicle during the parking space exit operation and could therefore collide with this moving object 17 when the host vehicle 1 maneuvers back. In the case of a road intersection as shown in FIG. 1, this object 17 can also be a following vehicle that has approached the host vehicle 1 to such an extent that the host vehicle 1 can no longer move back. If the overall probability of collision in step S48, consisting of the probability of collision with approaching objects 5, 6 and other moving surroundings objects 17, is further minimized, step S48 is continued to step S47 by continuing to maneuver back along the path. This continues until a minimum is reached, i.e., the probability of collision increases slightly again or the probability of collision drops completely to zero. If this local minimum is reached in step S48, the method according to the invention is terminated in step 49 and it was successfully possible to terminate a collision situation without a collision.

What is claimed is:

1. A safety apparatus for a vehicle, the vehicle including a device for automated longitudinal and lateral guidance of the vehicle for automatic maneuvering of the vehicle, at least one surroundings sensor system, and actuating units for actuating: (i) a vehicle steering system, and/or (ii) vehicle drive devices, and/or (iii) vehicle deceleration devices, the safety apparatus being configured to:
when the device for automated longitudinal and lateral guidance maneuvers the vehicle into a traffic space being traveled in, and the surroundings sensor system detects a moving object that has a probability of collision with the host vehicle, the safety apparatus is configured to brake the host vehicle to a standstill, change a direction of travel of the host vehicle, and maneuver the vehicle back along a travel path until the probability of collision is minimized.

2. The safety apparatus according to claim 1, characterized in that the device for automated longitudinal and lateral guidance of the vehicle is a device for maneuver assistance at low speeds.

3. The safety apparatus according to claim 2, wherein the vehicle has a detection unit for detecting a path traveled, a memory for storing a longitudinal movement and a lateral movement during the path traveled and, upon detection of the object that has a probability of collision with the host vehicle, the safety apparatus is configured to brake the host vehicle a standstill, change the direction of travel, and maneuver the host vehicle back along a stored path traveled along which the host vehicle was guided by the device for maneuver assistance device.

4. The safety apparatus according to claim 1, wherein the device for maneuver assistance is: (i) an automatic parking space exit system for removing the vehicle from a parking space, or (ii) a Front Cross Traffic Assist (FCTA) for exiting a driveway or for entering an intersection.

5. The safety apparatus according to claim 1, wherein the traffic space being traveled in is a lane of a road or an intersection region of a road intersection.

6. The safety apparatus according to claim 1, wherein the probability of collision results from a direction of movement of the object and the vehicle, their speeds and a possibility of avoiding the collision.

7. The safety apparatus according to claim 2, wherein the safety apparatus is configured to maneuver the vehicle back along a stored path traveled along which the host vehicle was guided by the device for maneuver assistance, until a risk of collision no longer exists.

8. The safety apparatus according to claim 7, wherein, during the maneuvering of the vehicle back along the stored path, a detection region of the surroundings sensor system is monitored using the at least one surroundings sensor system and, if a further object is detected within the stored path, safety apparatus is configured to brake the host vehicle to a standstill or to maneuver the host vehicle around the detected further object.

9. The safety apparatus according to claim 1, wherein the at least one surroundings sensor system includes: (i) radar sensors, or (ii) video sensors, or (ii) ultrasonic sensors, or (iv) lidar sensors, or (v) a combination of radar and/or video and/or ultrasonic and/or lidar sensor types, which are attached to the vehicle corners of the vehicle in such a way that they detect regions in front of and/or behind the vehicle.

10. A method for operating a safety apparatus for a vehicle, the vehicle having a device for automated longitudinal and lateral guidance of the vehicle for automatic maneuvering of the vehicle, the safety apparatus being supplied with signals from at least one surroundings sensor system, and the vehicle includes actuating units of: (i) a vehicle steering system, and/or (ii) vehicle drive devices, and/or (iii) vehicle deceleration devices, which can be actuated in order to guide the vehicle automatically, the method comprising:
when the device for automated longitudinal and lateral guidance maneuvers the vehicle into a traffic space being traveled in and the surroundings sensor system detects a moving object that has a probability of collision with the host vehicle:
braking the host vehicle to a standstill;
changing a direction of travel of the vehicle; and
maneuvering the host vehicle back along a path until the probability of collision is minimized.

11. The method according to claim 10, wherein the device for automated longitudinal and lateral guidance of the vehicle is a device for maneuver assistance at low speeds.

12. The method according to claim 10, wherein a path traveled by the vehicle is detected in a detection unit, a longitudinal movement and a lateral movement while the path is being traveled, and the path traveled, are stored in a memory, and, upon detection of the object that has a probability of collision with the host vehicle, the host vehicle is braked to a standstill, the direction of travel is changed and the host vehicle is maneuvered back along the stored path along which the host vehicle was guided.

13. The method according to claim 12, wherein the maneuvering of the vehicle and/or the maneuvering back of the vehicle is only possible up to a predetermined maximum speed, the maximum speed being limited to 10 km/h or 5 km/h.

14. The method according to claim 11, wherein the device for maneuver assistance is: (i) an automatic parking space exit system for removing the vehicle from a parking space, or (ii) a Front Cross Traffic Assist (FCTA) for exiting a driveway or for entering an intersection.

15. The method according to claim 10, wherein the traffic space being traveled in is a lane of a road or an intersection region of a road intersection.

16. A non-transitory machine-readable storage medium on which is stored a computer program for operating a safety apparatus for a vehicle, the vehicle having a device for automated longitudinal and lateral guidance of the vehicle for automatic maneuvering of the vehicle, the safety apparatus being supplied with signals from at least one surroundings sensor system, and the vehicle includes actuating units of: (i) a vehicle steering system, and/or (ii) vehicle drive devices, and/or (iii) vehicle deceleration devices, which be actuated in order to guide the vehicle automatically, the computer program, when executed by a computer, causing the computer to perform the following steps:
when the device for automated longitudinal and lateral guidance maneuvers the vehicle into a traffic space being traveled in and the surroundings sensor system detects a moving object that has a probability of collision with the host vehicle:
braking the host vehicle to a standstill;
changing a direction of travel of the vehicle; and
maneuvering the host vehicle back along a path until the probability of collision is minimized.
